(19) United States
(12) Patent Application Publication
(10) Pub. No.: US 2004/0058842 A1
(43) Pub. Date: Mar. 25, 2004

(54) Detergent compositions

(75) Inventors: Mario Jovelino Nunzio, Del, Sao Paulo (BR); Paulo Cesar Puelle Andrade, Sao Paulo (BR); Andrew Thomas Steel, Sao Paulo (BR)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/664,397

(22) Filed: Sep. 15, 2003

(30) Foreign Application Priority Data
Sep. 19, 2002 (GB) 0221738.8

(51) Int. Cl. C11D 17/00

(52) U.S. Cl. 510/446; 510/455

(57) ABSTRACT

A particulate laundry detergent composition comprising effervescent granules, at a level of from 0.1 to less than 2 wt %, the effervescent granules comprising (a) from 20 to 80 wt % of an acid source and (b) from 20 to 80 wt % of a carbonate source is provided. Surprisingly the effervescent granules provide dispensing benefits at very low concentration levels.

### TECHNICAL FIELD

The present invention relates to particulate detergent compositions containing effervescent granules.

### BACKGROUND AND PRIOR ART

Particulate laundry detergent compositions must satisfy a wide range of practical constraints. As well as providing excellent cleaning and care, they must also satisfy numerous physical constraints which go beyond this basic requirement. For example it is known that the effervescence properties of certain added ingredients can provide improved dispensing qualities to the detergent composition. This can be achieved by adding two ingredients which react together in the presence of water to produce a gas, for example by using sodium carbonate and citric acid. It is also known to place the two reacting components together in a single granule. Such a single granule is often referred to in the art as an effervescent granule.

U.S. Pat. No. 4,252,664 (Colgate-Palmolive) discloses the use of an effervescent granule comprising a gas-producing agent (preferably a carbonate) and an acid (preferably a solid acid). The effervescent granule is present in the full formulation at a level of from 5 to 10 wt %.

A series of patent applications have published which disclose effervescent granules which also contain detergent ingredients such as surfactant and builder:

WO 98 42811 (Procter & Gamble) discloses a detergent granule of size 1.0 to 4.5 mm which comprises an acid source and an alkali source.

WO 98 46714 (Procter & Gamble) discloses a substantially anhydrous effervescent particle of size 0.075 to 20 mm.

WO 98 46715 (Procter & Gamble) discloses a substantially anhydrous foaming component comprising an anhydrous surface active component (e.g. surfactant) and an effervescence component (e.g. acid or alkali source).

WO 98 46716 (Procter & Gamble) discloses a dry effervescent granule comprising an acid, a carbonate source and a binder, wherein the acid and carbonate source are in close physical proximity.

More recently, it has been discovered that effervescent granules may be improved by controlling the particle sizes of its constituents:

WO 00 34422 (Procter & Gamble) discloses an effervescence component which comprises an acid source and a carbonate source wherein at least 75% of the acid source has a particle size of from 0.1 to 150 microns. Preferably the carbonate source also has a defined particle size and the granule is preferably coated in a nonionic surfactant.

WO 01 30949 (Procter & Gamble) discloses a reactive particle comprising two particulate reactants in which the particle number ratio of the first reactant to the second is at least 50:1. Preferably the median particle size of the second to the first reactant is at least 2:1.

The present inventors have surprisingly found that specific types of effervescent granules which comprises an acid source and a carbonate source at a high concentration provides an effervescent granule with improved dispensing, dispersion and dissolution properties which allows them to be incorporated in detergent composition at surprisingly low levels thereby reducing their cost.

### STATEMENT OF INVENTION

The present invention provides a particulate laundry detergent composition comprising effervescent granules, at a level of from 0.1 to less than 2 wt %, the effervescent granules comprising:

(a) from 20 to 80 wt % of an acid source and;

(b) from 20 to 80 wt % of a carbonate source.

### DETAILED DESCRIPTION OF THE INVENTION

The Effervescent Granule

The effervescent granule of the present invention comprises from 20 to 80 wt % of an acid source and from 20 to 80 wt % of a carbonate source. The acid source and carbonate source are preferably in particulate form and therefore each granule would contain discrete particles of acid and carbonate source.

The granule preferably comprises from 30 to 60 wt %, more preferably from 40 to 50 wt % of the carbonate source. The granule preferably comprises from 30 wt % to 60 wt %, more preferably from 40 wt % to 50 wt % of the acid source.

It is preferred that the majority of the granule is comprised of the carbonate and the acid source and that more preferably the carbonate source and the acid source make up from 50 to 100 wt %, preferably from 60 to 99 wt %, more preferably from 70 to 95 wt %, most preferably from 80 to 90 wt % of the granule.

The granules preferably have a particle size of from 0.2 to 10 mm, preferably from 0.5 to 5 mm, more preferably 0.8 to 4 mm, most preferably from 1 to 2 mm. This helps to provide a highly effective localised fizzing action.

The granule may also comprise a drying agent such as a silica gel to ensure that the granule remains dry during storage.

The granule may also comprise a binder to help hold it together and it is preferred that such a binder is a polyethylene glycol or a polypropylene glycol.

The granules preferably also comprises a colourant in order to contrast their appearance from that of the detergent compositions to which they are added.

The Acid Source

The acid source reacts with the carbonate source in the presence of water to produce carbon dioxide gas.

Preferably the acid source is a particulate material and has a narrow particle size distribution such that at least 50 wt %, preferably at least 60 wt %, more preferably at least 70 wt %, most preferably at least 80 wt % of particles have a size of from 150 to 350 microns.

Preferably the acid source is an organic acid. Preferably the acids are mono-, bi- or tri-protonic acids. Such preferred acids include mono- or polycarboxylic acids preferably citric acid, adipic acid, glutaric acid, citramalic acid, tartaric acid, maleic acid, malic acid, succinic acid, malonic acid. Such acids are preferably used in their acidic forms, and it may be preferred that their anhydrous forms are used, or mixtures thereof. Citric acid is the most highly preferred.

The Carbonate Source

The carbonate source reacts with the acid source in the presence of water to produce carbon dioxide gas.

The carbonate source is preferably selected from alkali and/or alkaline earth metal salts of carbonate, bicarbonate, sesquicarbonate and mixtures thereof. A highly preferred carbonate source is sodium bicarbonate.

Sodium bicarbonate and sodium carbonate may be advantageously combined in a weight ratio of greater than 3:2, preferably at least 2:1, more preferably at least 3:1.

The Optional Solid Surfactant Particles

In order to enhance the fizzing action and to provide a positive cue for the end user, the effervescent granules of the present invention may comprise solid surfactant particles. It is preferred that in its isolated state the surfactant is sufficiently solid such that it is pourable.

As desired, the granule may comprises from 1 to 15 wt %, preferably from 2 to 10 wt %, more preferably from 3 to 8 wt % of solid surfactant particles.

Preferably the surfactant has a melting point of at least 30° C., preferably at least 40° C., more preferably at least 50° C.

Any conventional detergent surfactant is suitable for the present invention provided that it meets the criterion of being solid and particulate. Highly preferred surfactants are the alkyl sulphate type surfactants, preferably a C₈-C₁₅ primary alkyl sulphate, more preferably a C₁₀-C₁₄ primary alkyl sulphate.

Preferably the granules are substantially free of alkyl benzene sulphonate surfactants, because of their hygroscopicity. In this context, ‘substantially free’ means less than 5 wt % of the effervescent granule, preferably less than 3 wt %, more preferably less than 1 wt %, most preferably completely absent.

Preferably the surfactant particles have a d₅₀ particle size of greater than 100 microns, preferably from 150 to 800 microns.

In a particularly preferred embodiment, the ratio of the particle size of the effervescent granule to the d₅₀ particle size of the surfactant is greater than 5:1, preferably from 6:1 to 1000:1.

The Method of Manufacture

The effervescent granules according to the present invention may be made by any suitable process, such as for example by granulation, roll-compaction, extrusion or a combination thereof.

The Detergent Composition

The effervescent granules of the present invention are intended to be added to a conventional particulate laundry detergent composition. The granules provide excellent benefits to powders comprising surfactants. This benefit is surprisingly not diminished at reduced levels of inclusion. For the purposes of the present invention the detergent compositions comprise from 0.1 to less than 2 wt % of effervescent granules. Preferably they are present at a level of from 0.1 to 1.9 wt %. They may even be present at a level of from 0.5 to 1.5 wt %, or even from 0.5 to 1.2 wt %. Such low levels allow detergent compositions with the benefits of an effervescent granule to be manufactured more cheaply.

Detergent compositions according to the present invention preferably comprise a base powder which comprises surfactant and optionally builder and is characterised by substantial homogeneity. The detergent compositions preferably also comprise ingredients which are not part of the base powder and are ‘post-dosed’ to the composition. The detergent compositions of the present invention preferably comprises a base powder which has enough surfactant in it to comprise at least 5 wt %, preferably from 5 wt % to 50 wt %, based on the whole composition. Hence a lower level of base powder in the composition will require a higher concentration of surfactant in said base powder. Detergent compositions with a higher level of surfactant have increasingly poorer dispensing properties and therefore the present invention is particularly suitable where the base powder comprises surfactant at a level of from 10 to 50 wt %, preferably from 12 to 40 wt %, more preferably from 15 to 30 wt % based on the whole composition. The surfactant in the base powder may be any one or a mixture of surfactants common in the art as described below but is preferably C₁₂-C₁₄ alkyl benzene sulphonate.

The effervescent granules of the present invention are particularly suitable for inclusion into so called ‘low cost’ particulate laundry detergent compositions. Such compositions are limited in the amount of high cost ingredients such as bleach and enzyme ingredients and often contain a substantial amount of so-called ‘filler salts’ such as sodium carbonate or sodium sulphate. Hence a preferred detergent composition has: zero to 10 wt % postdosed bleach ingredients; preferably zero to 5 wt % bleach ingredients; zero to 0.6 wt % enzyme granules, preferably zero to 0.4 wt % enzyme granules; at least 10 wt %, preferably from 12 to 20 wt %, postdosed sodium carbonate, a base powder with at least 10 wt %, preferably from 12 to 20 wt %, sodium sulphate, or any combination thereof.

Detergent Ingredients

Detergent compositions of the invention contain detergent-active compounds and detergency builders, and may optionally contain bleaching components and other active ingredients to enhance performance and properties.

Detergent-active compounds (surfactants) may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch. The preferred detergent-active compounds that can be used are soaps and synthetic non-soap anionic and nonionic compounds. The total amount of surfactant present is suitably within the range of from 5 to 40 wt %.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 0.10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺ X⁻ wherein the R groups are long or short hydrocarbyl chains, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

Detergent compositions suitable for use in most automatic fabric washing machines generally contain anionic non-soap surfactant, or nonionic surfactant, or combinations of the two in any ratio, optionally together with cationic, amphoteric or zwitterionic surfactants, optionally together with soap.

The detergent compositions of the invention also contain one or more detergency builders. The total amount of detergency builder in the compositions will suitably range from 5 to 80 wt %, preferably from 10 to 60 wt %.

Suitable inorganic non-phosphorus containing builders include crystalline and amorphous aluminosilicates, for example zeolites as disclosed in GB 1 473 201 (Henkel); amorphous aluminosilicates as disclosed in GB 1 473 202 (Henkel); and mixed crystalline/amorphous aluminosilicates as disclosed in GB 1 470 250 (Henkel); and layered silicates as disclosed in EP 164 514B. Inorganic phosphate builders, for example, sodium orthophosphate, pyrophosphate and tripolyphosphate, may also be present.

Aluminosilicates, include the zeolite used in most commercial particulate detergent compositions, namely zeolite A. Advantageously, however, maximum aluminium zeolite P (zeolite MAP) described and claimed in EP 384 070B (Unilever) may be used. Zeolite MAP is an alkali metal aluminosilicate of the P type having a silicon to aluminium ratio not exceeding 1.33, preferably not exceeding 1.15, and more preferably not exceeding 1.07.

Suitably the builder system comprises a zeolite (for example zeolite A) and optionally an alkali metal citrate and/or a crystalline layered silicate (for example SKS-6 ex Hoechst).

Examples of phosphorus-containing inorganic detergency builders include the water-soluble salts, especially the alkali metal salts of pyrophosphates, orthophosphates, polyphosphates and phosphonates.

The phosphorus containing inorganic builder is preferably pyrophosphate or polyphosphate. Specific examples of inorganic phosphate builders include sodium and potassium tripolyphosphates, orthophosphates and hexametaphosphates.

Organic builders that may be present include polycarboxylate polymers such as polyacrylates and acrylic/maleic copolymers; monomeric polycarboxylates such as citrates, gluconates, oxydisuccinates, glycerol mono-, di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts. These materials are preferably present in alkali metal salt, especially sodium salt, form. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %. Builders, both inorganic and organic, are preferably present in alkali metal salt, especially sodium salt, form.

Detergent compositions according to the invention may also suitably contain a bleach system. Preferably this will include a peroxy bleach compound, for example, an inorganic persalt or an organic peroxyacid, capable of yielding hydrogen peroxide in aqueous solution. Preferred inorganic persalts are sodium perborate monohydrate and tetrahydrate, and sodium percarbonate. The sodium percarbonate may have a protective coating against destabilisation by moisture. The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %. Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA), diethylenetriamine pentaacetate (DTPA), ethylenediamine disuccinate (EDDS), and the polyphosphonates such as the Dequests (Trade Mark), ethylenediamine tetramethylene phosphonate (EDTMP) and diethylenetriamine pentamethylene phosphate (DETPMP).

Bleach ingredients are postdosed.

The compositions of the invention may contain alkali metal, preferably sodium, carbonate, in order to increase detergency and ease processing. Sodium carbonate may suitably be present in amounts ranging from 1 to 60 wt %, preferably from 2 to 40 wt %. Sodium carbonate may be included in either or both base granule, and/or may be postdosed.

As previously indicated, sodium silicate may also be present. The amount of sodium silicate may suitably range from 0.1 to 5 wt %. Sodium silicate may be postdosed, for example, as granular sodium disilicate, or as sodium carbonate/sodium silicate cogranules, for example, Nabion (Trade Mark) 15 ex Rhodia Chimie.

Powder flow may be improved by the incorporation of a small amount of a powder structurant. Examples of powder structurants, some of which may play other roles in the formulation as previously indicated, include, for example, fatty acids (or fatty acid soaps), sugars, acrylate or acrylate/maleate polymers, sodium silicate, and dicarboxylic acids (for example, Sokalan (Trade Mark) DCS ex BASF). One preferred powder structurant is fatty acid soap, suitably present in an amount of from 1 to 5 wt %.

Other materials that may be present in detergent compositions of the invention include antiredeposition agents such as cellulosic polymers; soil release agents; anti-dye-transfer agents; fluorescers; inorganic salts such as sodium sulphate; enzymes (proteases, lipases, amylases, cellulases); dyes; coloured speckles; perfumes; and fabric conditioning compounds. This list is not intended to be exhaustive.

### EXAMPLES

An effervescent granule was made with the following composition:

| Ingredient | Wt % |
|---|---|
| Citric acid | 38 |
| Sodium bicarbonate | 42 |
| Sodium carbonate | 10 |
| Sodium C₁₂₋₁₄ alkyl sulphate | 5 |
| Polypropyleneglycol | 4.5 |
| Silica Gel | 0.5 |
| Total | 100 |

The sodium carbonate had a d₅₀ particle size of about 150 microns. The sodium bicarbonate had a d₅₀ particle size of about 120 microns. The citric acid had a d₅₀ particle size of about 250 microns. The sodium C₁₂-C₁₄ alkyl sulphate was in particulate form (with a melting point in excess of 60° C.) and had a d₅₀ particle size of about 200 microns.

The sodium carbonate, sodium bicarbonate, silica gel, sodium lauryl sulphate and citric acid were mixed together to provide a dry-mix. Polypropylene glycol was then added to produce a wetted mixture. The resultant mixture was then granulated in a sieve-type granulator with 2 mm holes. The extrudates were then sliced into cylinders with a length of approximately 2 mm.

1 parts of the effervescent granule was mixed with 99 parts of a phosphate detergent powder with a formulation given below:

| Ingredient | Wt % |
|---|---|
| Base Powder | |
| Sodium C₁₂ alkyl benzene | 18.0 |
| sulphonate | |
| Sodium tripolyphosphate | 12.0 |
| Sodium silicate | 7.5 |
| Sodium sulphate | 26.9 |
| SCMC | 0.50 |
| Optical brightener | 0.18 |
| Photobleach | 0.03 |
| Silicone | 0.02 |
| Salts + moisture | 0.5 |
| Post Dosed | |
| Sodium carbonate | 15.0 |
| Sodium sulphate | 10.0 |
| Protease | 0.24 |
| Amylase | 0.10 |
| Sodium perborate | 1.50 |
| monohydrate | |
| TAED | 0.50 |
| Perfume | 0.24 |
| Moisture | 6.8 |
| Total | 100.00 |

The resultant detergent powder gave an attractive effervescent action when added to wash water despite the very low level of effervescent granule.

1. A particulate laundry detergent composition comprising effervescent granules, at a level of from 0.1 to less than 2 wt %, the effervescent granules comprising:
(a) from 20 to 80 wt % of an acid source and;
(b) from 20 to 80 wt % of a carbonate source.

2. A detergent composition as claimed in claim 1, which comprises from 0.1 to 1.9 wt %, preferably from 0.5 to 1.5 wt %, of the effervescent granule.

3. A detergent composition as claimed in claim 1, wherein the effervescent granules comprise from 30 wt % to 60 wt %, preferably from 40 wt % to 50 wt % of the acid source.

4. A detergent composition as claimed in claim 1, wherein the effervescent granules comprise from 30 to 60 wt %, preferably from 40 to 50 wt % of the carbonate source.

5. A detergent composition as claimed in claim 1, wherein the effervescent granule comprises from 50 to 100 wt %, preferably from 60 to 99 wt %, more preferably from 70 to 95 wt %, most preferably from 80 to 90 wt %, of the total of the acid and carbonate source.

6. A detergent composition as claimed in claim 1, wherein the acid source is citric acid.

7. A detergent composition as claimed in claim 1, wherein the carbonate source is selected from alkali and/or alkaline earth metal salts of carbonate, bicarbonate, sesquicarbonate and mixtures thereof.

8. A detergent composition as claimed in claim 1, which comprises a base powder, wherein the base powder comprises surfactant at a level of at least 5 wt %, preferably from 5 to 50 wt %, based on the whole composition.

9. A detergent composition as claimed in claim 1, which also comprises solid surfactant particles, preferably from 1 to 15 wt %, preferably from 2 to 10 wt %, more preferably from 3 to 8 wt % of solid surfactant particles.

10. A detergent composition as claimed in claim 1, wherein the granules are substantially free of alkyl benzene sulphonate surfactant.
